(19) United States
(12) Patent Application Publication
(10) Pub. No.: US 2011/0242076 A1
(43) Pub. Date: Oct. 6, 2011

(54) DEVICE FOR DRIVING DATA AND METHOD THEREOF USED FOR LIQUID CRYSTAL DISPLAY

(75) Inventors: Chen-Ming Hsu, Tainan County (TW); Yaw-Guang Chang, Tainan County (TW)

(73) Assignee: HIMAX TECHNOLOGIES LIMITED, Tainan County (TW)

(21) Appl. No.: 12/753,208

(22) Filed: Apr. 2, 2010

(51) Int. Cl. G09G 5/00

(52) U.S. Cl. 345/209; 345/212; 345/96

(57) ABSTRACT

A device for driving data used for a liquid crystal display includes: a first latch circuit and a second latch circuit for forming first latched data and second latched data; a first regulating circuit and a second regulating circuit for regulating the first latched data or the second latched data; a first switch, a second switch, a third switch and a fourth switch respectively coupled between the first latch circuit or the second circuit and the first regulating circuit or the second regulating circuit. The first and the second latched data become a first pair of differential signals when the first switch and the fourth switch are turned on. The first and the second latched data become a second pair of differential signals which are opposite to the first pair of differential signals when the second switch and the third switch are turned on.

### FIELD OF THE INVENTION

The present invention relates to a device for driving data and method thereof and in particular relates to a device for driving data and method thereof used for a liquid crystal display.

### DESCRIPTION OF THE RELATED ART

Generally, a source driver is only able to be applied to a specific panel. That is because there may be pin disposition differences between source drivers and panels. For example, bus data input into a source driver through a first set of input pins are processed into an analog signal with a voltage which is output at a first output pin, and then the analog signal is input into a panel through a first input pin of the panel. The route for which the bus data can be input and the analog signal can be output is always fixed. Thus, if the source driver is applied in a different panel, wherein the input pin locations of the source driver and different panel are different, the analog signal output at the first output pin of the source driver will not consistently connect with the first input pin of the different panel. Usually, in order to make a source driver compatible with different panels, the conventional solution is to redesign the layout of the source driver, or develop a new source driver for each panel.

Thus, a source driver that is capable of being applied in different panels is called for.

### BRIEF SUMMARY OF INVENTION

A detailed description is given in the following embodiments with reference to the accompanying drawings.

The present invention provides a device for driving data used for a liquid crystal displays. The device for driving data comprises: a first latch circuit and a second latch circuit for respectively latching first data and second data to form first latched data and second latched data; a first regulating circuit and a second regulating circuit for regulating the first latched data or the second latched data to a high level signal or a low level signal; a first switch coupled between the first latch circuit and the first regulating circuit; a second switch coupled between the first latch circuit and the second regulating circuit; a third switch coupled between the second latch circuit and the first regulating circuit; and a fourth switch coupled between the second latch circuit and the second regulating circuit. The first and the second latched data are respectively input into the first and the second regulating circuits to form a first pair of differential signals when the first switch and the fourth switch are turned on. Also, the first and the second latched data are respectively input into the second and the first regulating circuits to form a second pair of differential signals which are opposite to the first pair of differential signals when the second switch and the third switch are turned on.

The present invention provides a method for driving data used for liquid crystal displays. The method for driving data comprises: latching first data and second data by a first latch circuit and a second latch circuit respectively to form first latched data and second latched data; regulating the first latched data or the second latched data to a high level signal or a low level signal by a first regulating circuit and a second regulating circuit; providing a first switch coupled between the first latch circuit and a first regulating circuit; providing a second switch coupled between the first latch circuit and a second regulating circuit; providing a third switch coupled between the second latch circuit and the first regulating circuit; providing a fourth switch coupled between the second latch circuit and the second regulating circuit; turning on the first switch and the fourth switch such that the first and the second latched data are respectively input into the first and the second regulating circuits to form a first pair of differential signals; and turning on the second switch and the third switch such that the first and the second latched data are respectively input into the second and the first regulating circuits to form a second pair of differential signals which are opposite to the first pair of differential signals.

The above-mentioned device for driving data and method thereof is able to switch or exchange signal routines inside of a device so that the device can be compatible with various panels.

### BRIEF DESCRIPTION OF DRAWINGS

The present invention can be more fully understood by reading the subsequent detailed description and examples with references made to the accompanying drawings, wherein:

FIG. 1 is a schematic diagram showing a device for driving data used for a liquid crystal display;

FIG. 2 is a diagram showing a first operative type of the device for driving data used for a liquid crystal display of FIG. 1;

FIG. 3 is a diagram showing a second operative type of the device for driving data used for the liquid crystal display of FIG. 1;

FIG. 4 is a diagram showing a third operative type of the device for driving data used for the liquid crystal display of FIG. 1;

FIG. 5 is a diagram showing a fourth operative type of the device for driving data used for the liquid crystal display of FIG. 1; and

FIG. 6A-6D is a flowchart illustrating a method for driving data used for a liquid crystal display.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

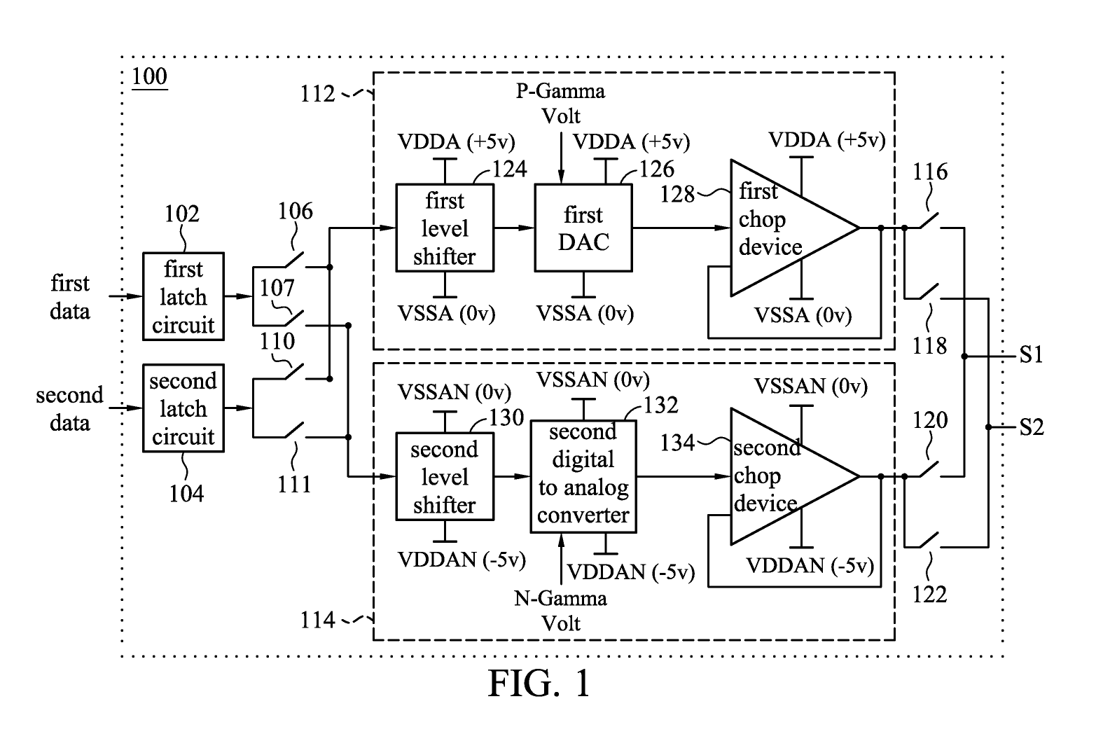

FIG. 1 is a schematic diagram showing a device for driving data used for a liquid crystal display. The device 100 includes a first latch circuit 102, a second latch circuit 104, a first switch 106, a second switch 107, a third switch 110, a fourth switch 111, a first regulating circuit 112, a second regulating circuit 114, a fifth switch 116, a sixth switch 118, a seventh switch 120 and an eighth switch 122.

The first latch circuit 102 and the second latch circuit 104 are respectively used to latch the first data and the second data to form the first latched data and the second latched data which is to be output. In one embodiment, data width can be a bit or a bus width, such as a byte, a word or longer.

The first regulating circuit 112 is used to regulate the first latched data or the second latched data to a high level signal. In one embodiment, the voltage level of the high level signal may be from 0 v to 5 v. The second regulating circuit 114 is used to regulate the first latched data or the second latched data to a low level signal. In one embodiment, the voltage level of the low level signal may be from 0 v to −5 v.

The first switch 106 is coupled between the first latch circuit 102 and the first regulating circuit 112. The second switch 107 is coupled between the first latch circuit 102 and the second regulating circuit 114. The third switch 110 is coupled between the second latch circuit 104 and the first regulating circuit 112. The fourth switch 111 is coupled between the second latch circuit 104 and the second regulating circuit 114. The fifth switch 116 is coupled between the first regulating circuit 112 and a first terminal S1. The sixth switch 118 is coupled between the first regulating circuit 112 and a second terminal S2. The seventh switch 120 is coupled between the second regulating circuit 114 and the first terminal S1. The eighth switch 122 is coupled between the second regulating circuit 114 and the second terminal S2.

The first and the second latched data may be input into the first and the second regulating circuits 112, 114 through the first switch 106, the second 107, the third switch 110 or the fourth switch 111 to form two opposite pairs of differential signals, and the pairs of differential signals may be delivered to the terminals S1 and S2 through the fifth switch 116, the sixth switch 118, the seventh switch 120 or the eighth switch 122.

Usually, the first and the fourth switches 106, 111 are simultaneously turned on, and the second and the third switches 107, 110 are simultaneously turned on. The fifth and the eighth switches 116, 122 are simultaneously turned on, and the sixth and the seventh switches 118, 120 are simultaneously turned on.

In one embodiment, the first regulating circuit 112 further includes a first level shifter 124, a first digital to analog converter 126 and a first chop device 128.

The first level shifter 124 is used to generate a first shifted signal with a voltage of between zero and a positive voltage according to input data such as the first latched data or the second latched data. The first digital to analog converter 126 is used to convert the first shifted signal into a first analog signal with a voltage of between zero and the positive voltage. The first chop device 128 is used to restrict the voltage of the first analog signal to between zero and the positive voltage. Note that the restricted output signal of the first chop device 128 is the high level signal mentioned before. The positive voltage may be 5 v, but is not limited thereto. The first chop device 128 may be an operational amplifier in the embodiment, but is not limited thereto.

In one embodiment, the second regulating circuit 114 further includes a second level shifter 130, a second digital to analog converter 132 and a first chop device 134.

The second level shifter 114 is used to generate a second shifted signal with a voltage of between zero and a negative voltage according to input data such as the first latched data or the second latched data. The second digital to analog converter 132 is used to convert the second shifted signal into a second analog signal with a voltage of between zero and the negative voltage. The first chop device 134 is used to restrict the second analog signal to between zero and the positive voltage. Note that the restricted output signal of the second chop device 134 is the low level signal mentioned before. The negative voltage may be −5 v, but is not limited thereto. The chop device 134 may be an operational amplifier, but is not limited thereto.

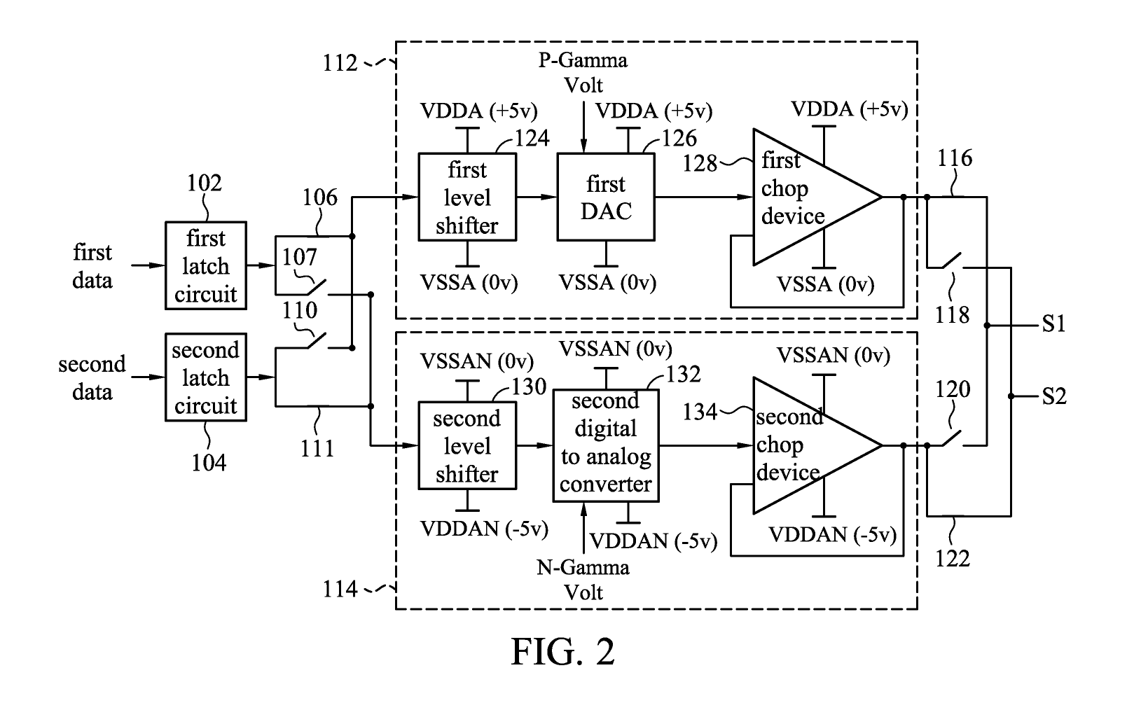

FIG. 2 is a diagram showing a first operative type of the device for driving data used for the liquid crystal display of FIG. 1. The first operative type is used to turn on the first switch 106 and the fourth switch 111, and the fifth switch 116 and the eighth switch 122. The first data is latched in the first latch circuit 102. The first latched data is sent to the first level shifter 124 of the first regulating circuit 112 through the first switch 106. The first latched data is processed by the first level shifter 124, the first digital to analog converter 126 and the first chop device 128 to form a high level signal with a voltage which is limited between 0 v and 5 v. The high level signal is sent to the first terminal S1 through the fifth switch 116. The second data is latched in the second latch circuit 104. The second latched data is sent to the second level shifter 130 of the second regulating circuit 114 through the fourth switch 111. The second latched data is processed by the second level shifter 130, the second digital to analog converter 132 and the second chop device 134 to form a low level signal with a voltage which is limited between 0 v and −5 v. The low level signal is sent to the second terminal S2 through the eighth switch 122.

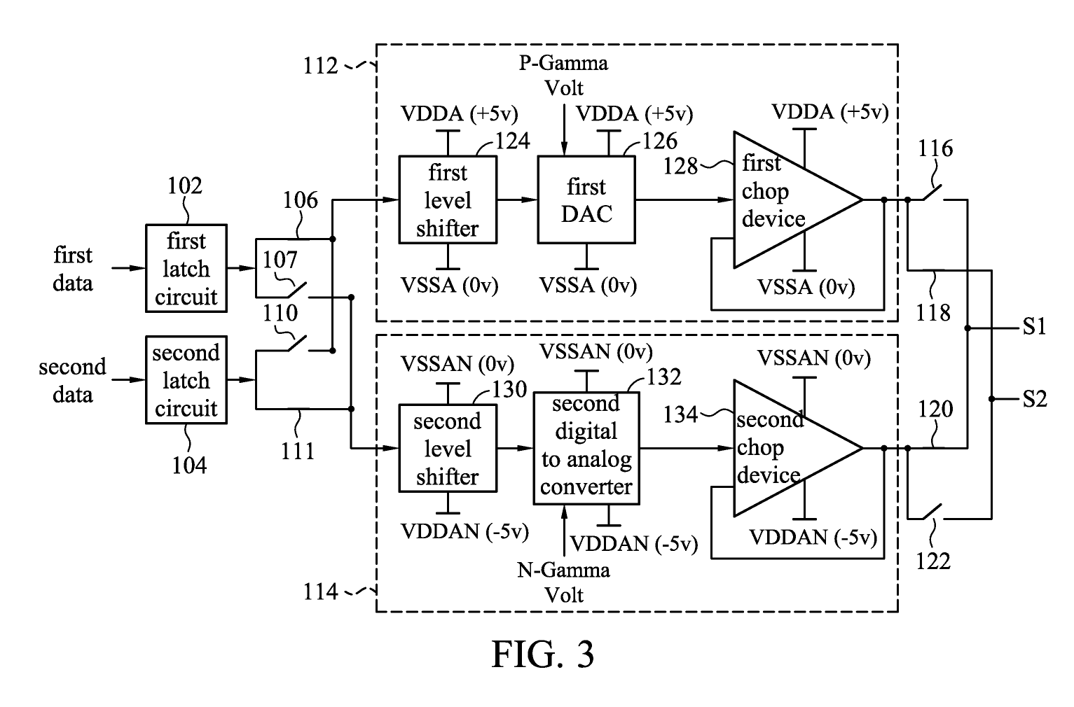

FIG. 3 is a diagram showing a second operative type of the device for driving data used for the liquid crystal display of FIG. 1. The second operative type is used to turn on the first switch 106 and the fourth switch 111, and the sixth switch 118 and the seventh switch 120. The first data is latched in the first latch circuit 102. The first latched data is sent to the first level shifter 124 of the first regulating circuit 112 through the first switch 106. The first latched data is processed by the first level shifter 124, the first digital to analog converter 126 and the first chop device 128 to form a high level signal with a voltage which is limited between 0 v and 5 v. The high level signal is sent to the second terminal S2 through the sixth switch 118. The second data is latched in the second latch circuit 104, the second latched data is sent to the second level shifter 130 of the second regulating circuit 114 through the fourth switch 111. The second latched data is processed by the second level shifter 130, the second digital to analog converter 132 and the second chop device 134 to form a low level signal with a voltage which is limited between 0 v and −5 v. The low level signal is sent to the first terminal S1 through the seventh switch 120.

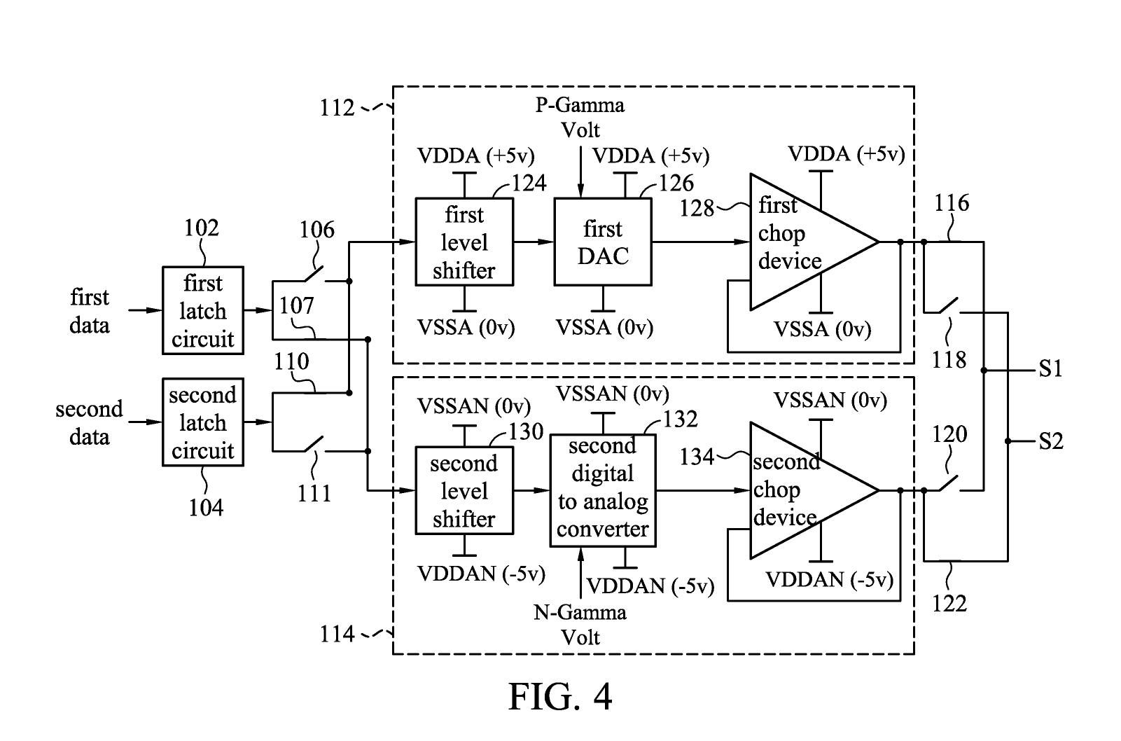

FIG. 4 is a diagram showing a third operative type of the device for driving data used for the liquid crystal display of FIG. 1. The third operative type is used to turn on the second switch 107 and the third switch 110, and the fifth switch 116 and the eighth switch 122. The first data is latched in the first latch circuit 102. The first latched data is sent to the second level shifter 130 of the second regulating circuit 114 through the second switch 107. The first latched data is processed by the second level shifter 130, the second digital to analog converter 132 and the second chop device 134 to form a low level signal with a voltage which is limited between 0 v and −5 v. The low level signal is sent to the second terminal S2 through the eighth switch 116. The second data is latched in the second latch circuit 104, the second latched data is sent to the first level shifter 124 of the second regulating circuit 112 through the third switch 110. The second latched data is processed by the first level shifter 124, the first digital to analog converter 126 and the second chop device 128 to form a high level signal with a voltage which is limited between 0 v and 5 v. The high level signal is sent to the first terminal S1 through the fifth switch 116.

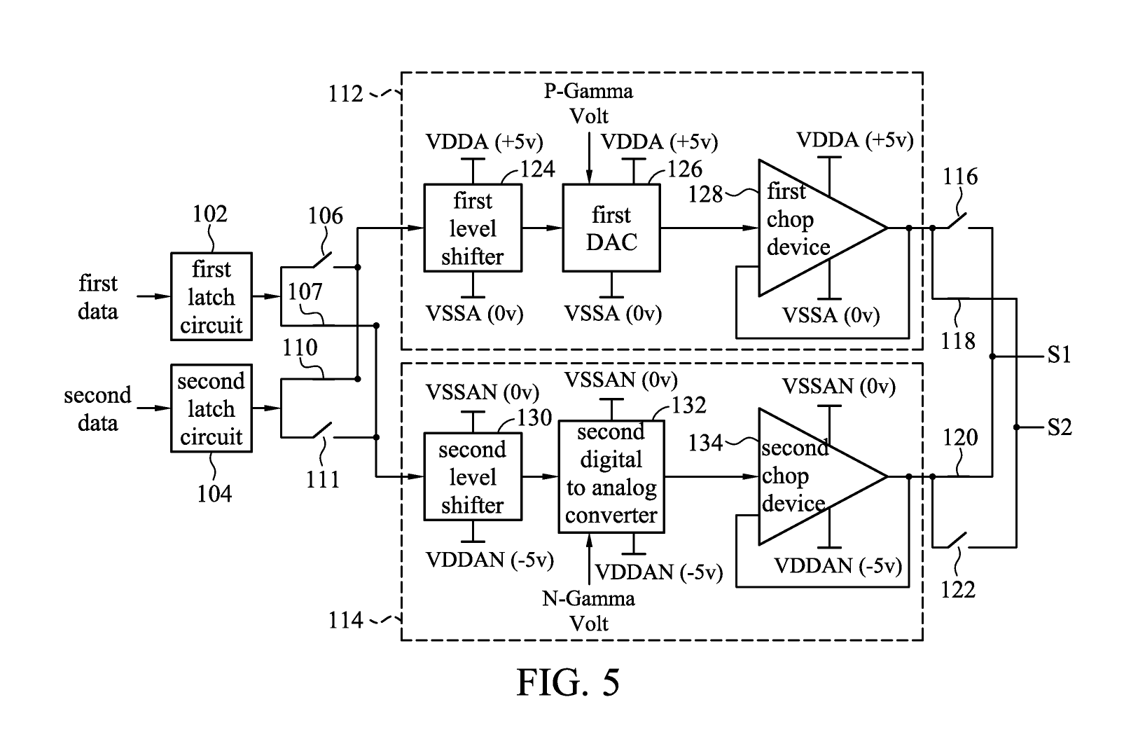

FIG. 5 is a diagram showing a fourth operative type of the device for driving data used for the liquid crystal display of FIG. 1. The fourth operative type is used to turn on the second switch 107 and the third switch 110, and the sixth switch 118 and the seventh switch 120. The first data is latched in the first latch circuit 102. The first latched data is sent to the second level shifter 130 of the second regulating circuit 114 through the second switch 108. The first latched data is processed by the second level shifter 130, the second digital to analog converter 132 and the second chop device 134 to form a low level signal with a voltage which is limited between 0 v and −5 v. The low level signal is sent to the first terminal S1 through the seventh switch 120. The second data is latched in the second latch circuit 104, the second latched data is sent to the first level shifter 124 of the second regulating circuit 112 through the third switch 110. The second latched data is processed by the first level shifter 124, the first digital to analog converter 126 and the second chop device 128 to form a high level signal with a voltage which is limited between 0 v and 5 v. The high level signal is sent to the second terminal S2 through the sixth switch 118.

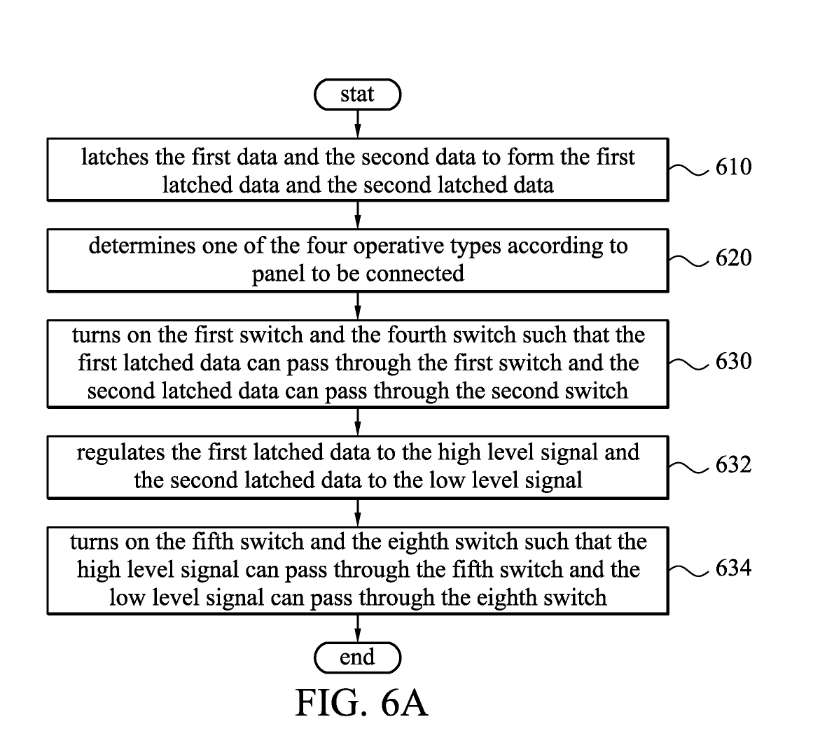

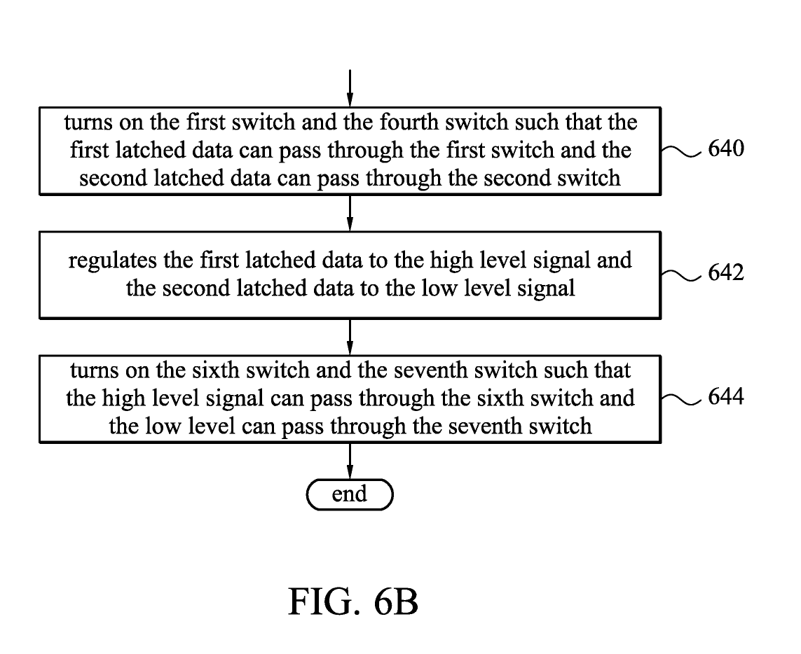

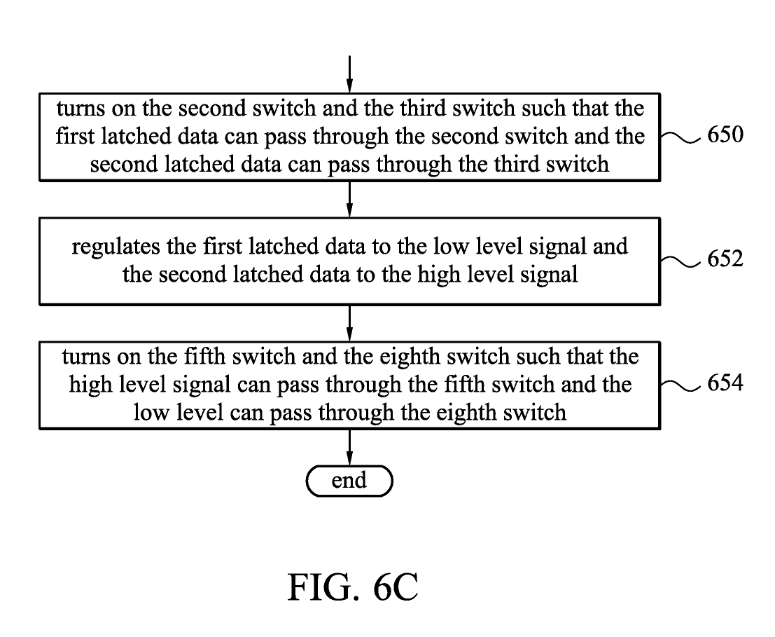

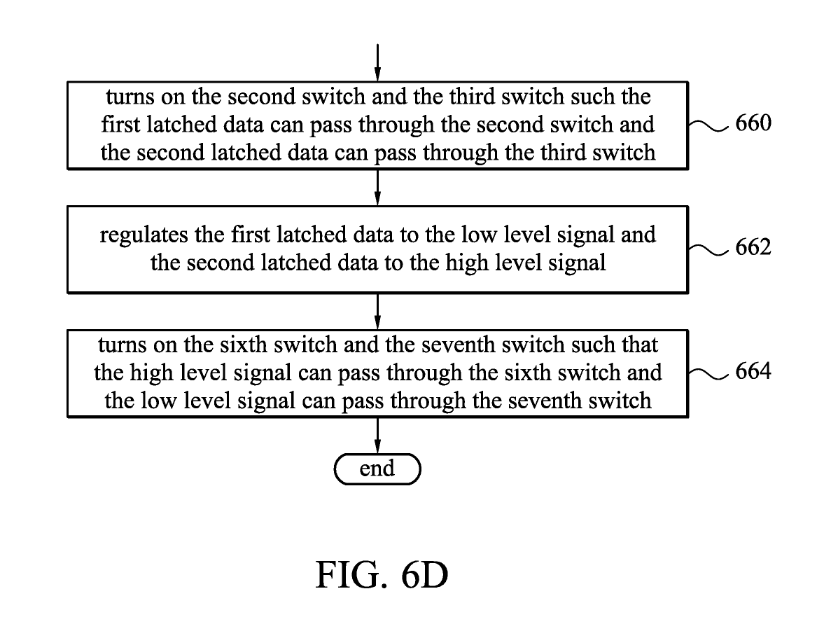

FIG. 6A-6D is a flowchart illustrating a method for driving data used for the liquid crystal display. In step 610, the device for driving data latches the first data and the second data to form the first latched data and the second latched data. The device for driving data then determines one of the four operative types according to a panel connected with the device in step 620. The first operative type is illustrated from step 630 to step 634 in FIG. 6A. The second operation type is illustrated from step 640-644 in FIG. 6B. The third operation type is illustrated from step 650-654 in FIG. 6C. The fourth operation type is illustrated from step 660-664 in FIG. 6D.

In the first operative type, the device for driving data turns on the first switch and the fourth switch such that the first latched data can pass through the first switch and the second latched data can pass through the fourth switch in the step 630. Next, the device for driving data regulates the first latched data to a high level signal and regulates the second latched data to a low level signal in the step 632. Finally, the device for driving data turns on the fifth switch and the eighth switch such that the high level signal can pass through fifth switch and the low level signal can pass through the eighth switch in the step 634.

In the second operative type, the device for driving data turns on the first switch and the fourth switch such that the first latched data can pass through the first switch and the second latched data can pass through the fourth switch in the step 640. Next, the device for driving data regulates the first latched data to a high level signal and regulates the second latched data to a low level signal in the step 642. Finally, the device for driving data turns on a sixth switch and an seventh switch such that the high level signal can pass through the sixth switch and the low level signal can pass through the seventh switch in the step 634.

In the third operative type, the device for driving data turns on the second switch and the third switch such that the first latched data can pass through the second switch and the second latched data can pass through the third switch in the step 650. Next, the device for driving data regulates the first latched data to a low level signal and regulates the second latched data to a high level signal in the step 652. Finally, the device for driving data turns on the fifth switch and the eighth switch such that the high level signal can pass through the fifth switch and the low level signal can pass through the eighth switch in the step 654.

In the fourth operative type, the device for driving data turns on the second switch and the third switch such that the first latched data can pass through the second switch and the second latched data can pass through the third switch in the step 660. Next, the device for driving data regulates the first latched data to the low level signal and regulates the second latched data to the high level signal in the step 662. Finally, the device for driving data turns on the sixth switch and the seventh switch such that the high level signal can pass through the sixth switch and the low level signal can pass through the seventh switch in the step 664.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for driving data used for a liquid crystal display, comprising:
a first latch circuit and a second latch circuit for respectively latching first data and second data to form first latched data and second latched data;
a first regulating circuit and a second regulating circuit for regulating the first latched data or the second latched data to a high level signal or a low level signal;
a first switch coupled between the first latch circuit and the first regulating circuit;
a second switch coupled between the first latch circuit and the second regulating circuit;
a third switch coupled between the second latch circuit and the first regulating circuit; and
a fourth switch coupled between the second latch circuit and the second regulating circuit;
wherein the first and the second latched data are respectively input into the first and the second regulating circuits to form a first pair of differential signals when the first switch and the fourth switch are turned on; and
wherein the first and the second latched data are respectively input into the second and the first regulating circuits to form a second pair of differential signals which are opposite to the first pair of differential signals when the second switch and the third switch are turned on.

2. The device as claimed in claim 1, further comprising:
a fifth switch coupled between the first regulating circuit and a first terminal;
a sixth switch coupled between the first regulating circuit and a second terminal;
a seventh switch coupled between the second regulating circuit and the first terminal; and
an eighth switch coupled between the second regulating circuit and the second terminal;
wherein the fifth and the eighth switches are simultaneously turned on so as to respectively deliver the high level signal and the low level signal to a first terminal and a second terminal, and the sixth and the seventh switches are simultaneously turned on so as to respectively deliver the high level signal and the low level signal to the second terminal and the first terminal.

3. The device as claimed in claim 1, wherein the first regulating circuit further comprises:
a first level shifter for generating first shifted data with a voltage of between zero and a positive voltage;
a first digital to analog converter for converting the first shifted data into a first analog signal with a voltage of between zero and a positive voltage; and
a first chop device for generating the high level signal with a voltage of between zero and the positive voltage according to the first analog signal.

4. The device as claimed in claim 1, wherein the second regulating circuit comprises:
a second level shifter for generating second shifted data with a voltage of between zero and a negative voltage;
a second digital to analog converter for converting the second shifted data into a second analog signal with a voltage of between zero and the negative voltage; and
a second chop device for generating the low level signal with a voltage of between zero and the negative voltage according to the second analog signal.

5. A method for driving data used for a liquid crystal display comprising:
latching first data and second data by a first latch circuit and a second latch circuit respectively to form first latched data and second latched data;
regulating the first latched data or the second latched data to a high level signal or a low level signal by a first regulating circuit and a second regulating circuit;
providing a first switch coupled between the first latch circuit and a first regulating circuit;
providing a second switch coupled between the first latch circuit and a second regulating circuit;
providing a third switch coupled between the second latch circuit and the first regulating circuit; and
providing a fourth switch coupled between the second latch circuit and the second regulating circuit;
turning on the first switch and the fourth switch such that the first and the second latched data are respectively input into the first and the second regulating circuits to form a first pair of differential signals;
turning on the second switch and the third switch such that the first and the second latched data are respectively input into the second and the first regulating circuits to form a second pair of differential signals which are opposite to the first pair of differential signals.

6. The method as claimed in claim 5, further comprising:
providing a fifth switch coupled between the first regulating circuit and a first terminal;
providing a sixth switch coupled between the first regulating circuit and a second terminal;
providing a seventh switch coupled between the second regulating circuit and the first terminal; and
providing an eighth switch coupled between the second regulating circuit and the second terminal;
wherein the fifth and the eighth switches are simultaneously turned on so as to respectively deliver the high level signal and the low level signal to a first terminal and a second terminal, and the sixth and the seventh switches are simultaneously turned on so as to respectively deliver the high level signal and the low level signal to the second terminal and the first terminal.

7. The method as claimed in claim 5, wherein regulating the first latched data or the second latched data to the high level signal further comprises:
generating first shifted data with a voltage of between zero and a positive voltage by a first level shifter;
converting the first shifted data into a first analog signal with a voltage of between zero and the positive voltage by a first digital to analog converter; and
generating the high level signal with a voltage of between zero and the positive voltage according to the first analog signal by a first chop device.

8. The method as claimed in claim 5, wherein regulating the first latched data or the second latched data to the low level signal further comprises:
generating second shifted data with a voltage of between zero and a negative voltage by a second level shifter;
converting the second shifted data into a second analog signal with a voltage of between zero and the negative voltage by a second digital to analog converter; and
generating the low level signal with a voltage of between zero and the negative voltage according to the second analog signal by a second chop device.
